(19) United States
(12) Patent Application Publication
(10) Pub. No.: US 2020/0076014 A1
(43) Pub. Date: Mar. 5, 2020

(54) CONTINUOUS HANDS-FREE BATTERY MONITORING AND CONTROL

(71) Applicant: GM Global Technology Operations LLC, Detroit, MI (US)

(72) Inventors: Matthew R. Garelli, Royal Oak, MI (US); Michael P. Barker, Troy, MI (US); Tamara R. Thomson, Hazel Park, MI (US); Theodore T. Kim, Rochester Hills, MI (US)

(73) Assignee: GM Global Technology Operations LLC, Detroit, MI (US)

(21) Appl. No.: 16/120,627

(22) Filed: Sep. 4, 2018

(51) Int. Cl. H01M 10/48; H01M 2/10; H01M 10/42; B60L 11/18

(52) U.S. Cl. CPC H01M 10/482; H01M 2/1077; H02J 7/0014; H01M 10/486; B60L 11/1851; H01M 10/4257

(57) ABSTRACT

A battery module includes battery cells and a cell monitoring unit (CMU). The CMU includes a radio frequency (RF) communications circuit and a cell sense circuit connected to a substrate, the latter in wireless communication with the RF communications circuit. The cell sense circuit measures battery data, including a cell voltage and a cell temperature of each battery cell. The CMU includes a microprocessor in communication with the RF communications and cell sense circuits. The microprocessor determines when the battery module has been dormant for a predetermined dormancy duration during which the battery cells are neither charging nor discharging. Responsive to such dormancy, a Long-Term Data Storage Mode is executed in which the RF communications circuit paired with the cell sense circuit, collects the battery data at a calibrated interval, and wirelessly transmits the battery data to flash memory of the CMU for storage therein.

### INTRODUCTION

Electrochemical battery packs are used to energize electric machines in a wide variety of host systems. For instance, motor torque from an electric machine may be transmitted to a transmission input member within a powertrain. The electric machine draws energy from and delivers electrical energy to individual battery cells of the battery pack as needed. The battery pack may be recharged by a charging current supplied from an offboard power supply, and in some embodiments via onboard energy regeneration. When the battery pack is actively charging or discharging, corresponding battery cell voltages and temperatures of the battery cells are closely monitored and regulated in real-time by a master battery controller.

Battery packs, particularly those used as a power supply in a hybrid electric or battery electric vehicle, may have a modular design. That is, a desired number of battery cells are arranged into a battery module, with multiple battery modules interconnected to form a battery pack or rechargeable energy storage system having an application-specific voltage capacity. The battery cells of a given battery module are interconnected via a conductive interconnect member or bus bar cap and enclosed in a protective housing to isolate the battery cells from moisture, dirt, and other debris. Each battery module may include a dedicated cell sense board (CSB) that is soldered to the battery cells. Multiple CSBs may be daisy-chained together and connected to the resident battery controller via wiring harnesses and end connectors to provide the requisite communications and electrical connectivity. During charging as well as when conducting a propulsion/drive operating mode, the individual hardwired CSBs may read individual battery cell voltages, temperatures, and other battery data and report the measurements in real-time to the battery controller as part of an onboard battery control strategy.

### SUMMARY

The present disclosure relates to hands-free monitoring and control of a battery module having a wireless, microprocessor-based cell monitoring unit (CMU). In addition to functions of the above-noted hardwired CSB, which monitors cell performance of a respective battery module in real-time during active charging/discharging operations and streams the battery data to a connected master battery controller, the present approach also enables selective battery data collection and local storage of battery data during extended periods of dormancy of the battery module.

Periods of such dormancy may be experienced prior to installation of an assembled battery module or a pack of multiple such modules into a host system, such as but not limited to a vehicle having an electrified powertrain. For instance, a battery module may be manufactured in one location and shipped, possibly over an extended distance, to an assembly plant located in another location. The battery modules may be warehoused between the point of manufacture and an ultimate point of integration into the host system.

As a result, several weeks or months of dormancy may pass before the battery modules are connected to a load and operational, i.e., actively charging or discharging the battery cells residing within the battery module. Such battery modules may contain a latent manufacturing defect that is not otherwise detectable until the battery modules are eventually energized and placed in communication with the resident battery controller. The extended periods of dormancy represent informational “black holes” that, left unfilled, may adversely affect long-term monitoring and control accuracy and efficiency.

The present approach is intended to enable automatic collection of time-lapse battery data over extended periods of dormancy. A microcontroller-based CMU with RF capability is used to achieve the desired ends. The CMU may be embodied as a printed circuit board assembly having a substrate, e.g., a molded plastic board or flexible circuit board (“flex circuit”), an RF communications circuit with an RF antenna or transceiver, and a cell sense circuit integrated with the RF circuit or in wireless communications therewith. Each CMU is electrically connected to individual battery cells of a given battery module and configured to measure battery data inclusive of corresponding cell voltages and cell temperatures.

Each CMU is programmed with a software switch situationally enabling multiple CMU operating modes, including a powered/streaming Normal Mode, a low-power Long-Term Storage Mode, and a Transitional Mode covering mode transitions between the Normal and Long-Term Storage Modes. The Normal Mode is similar to the real-time monitoring and streaming data output of the hardwired CSBs described above. That is, when the CMU is integrated into a host system and the battery module is commanded to actively charge or discharge its constituent battery cells, the CMU wirelessly streams the battery data to a master battery controller or other host computer in real-time. The Transitional Mode is a brief intervening mode between Normal and Long-Term Storage Modes. The Long-Term Storage Mode is automatically triggered in response to predetermined dormancy conditions, such as the battery module being dormant for a calibrated duration, regardless of whether such dormancy is due to a fault or merely extended periods of host system shutdown.

In the Long-Term Storage Mode, the RF communications circuit remains active and paired with other components of the CMU in a low-power mode, including the cell sense circuit. The microprocessor of the CMU wakes up at a calibrated interval, collects the battery data, and temporarily records the collected battery data in resident flash memory, e.g., in a linear or circular data buffer or array. The microprocessor then returns to a low-power “sleep” mode until collection of the next battery data sample is required. In this manner, uninterrupted local monitoring of the battery module is enabled without respect to the status of the battery module's connectivity with a master battery controller, which itself may not be present during extended periods of dormancy.

In some embodiments, the host computer has its own RF communications circuit and is present in wireless proximity to the battery module having the CMU described above. Also as noted above, assembled battery modules may be stored for extended periods of time in a warehouse before or after their transport to a final assembly facility, or the battery modules may be stored in shipping containers located aboard a truck, train, or container ship. In such cases, the collected battery data temporarily residing in flash memory of the CMU may be periodically offloaded to the host computer via initiation of an RF communications session, e.g., in response to a data request signal from the host computer. The host computer may thereafter compare the received battery data for the dormant battery module to corresponding thresholds, and may execute a suitable control action responsive to the battery data exceeding a maximum threshold and/or falling below a minimum threshold.

The present disclosure may be used advantageously prior to integration of the battery module in the host system. However, battery data collected in Long-Term Storage Mode during extended periods of dormancy may also be collected after integration, such as when an electric vehicle having an installed battery pack constructed of multiple battery modules is parked for several weeks or months at a time.

In an example embodiment, a battery module includes a plurality of battery cells and a CMU mounted to the battery module. The CMU includes a substrate, an RF communications circuit connected to the substrate, a cell sense circuit connected to the substrate and in wireless communication with the RF communications circuit, a microprocessor, and flash memory. The cell sense circuit is operable for measuring battery data, including a cell voltage and a cell temperature of each respective one of the battery cells. The microprocessor is in communication with the RF communications circuit and the cell sense circuit.

The microprocessor in this embodiment is configured to determine when the battery module has been dormant for a predetermined dormancy duration during which the battery cells are neither charging nor discharging, and, responsive to the battery module being dormant for the predetermined dormancy duration, to selectively execute a Long-Term Data Storage Mode in which the RF communications circuit is automatically paired with the cell sense circuit, collects the battery data at a calibrated interval, and wirelessly transmits the battery data to the flash memory for storage therein.

A method of monitoring and controlling the battery module is also disclosed. The method according to an example embodiment includes determining, via a microprocessor of the CMU in RF communication with an RF communications circuit and a cell sense circuit of the CMU, when the battery module has been dormant for a predetermined dormancy duration in which the battery cells are neither charging nor discharging. Responsive to the battery module being dormant for the predetermined dormancy duration, the method includes selectively executing a Long-Term Data Storage Mode, including pairing an RF communications circuit of the CMU with a cell sense circuit of the CMU, collecting battery data at a calibrated interval using the cell sense circuit, the battery data including cell voltages and cell temperatures of each respective one of the battery cells, and wirelessly transmitting the battery data via the RF communications circuit to flash memory of the CMU for storage therein.

The above summary is not intended to represent every embodiment or every aspect of the present disclosure. Rather, the foregoing summary merely provides an exemplification of some of the novel aspects and features set forth herein. The above features and advantages, and other features and advantages of the present disclosure, will be apparent from the following detailed description of representative embodiments and modes for carrying out the present disclosure when taken in connection with the accompanying drawings and the appended claims.

### BRIEF DESCRIPTION OF THE DRAWINGS

FIG. 1 is a schematic illustration of a lifecycle sequence of an example set of battery modules having a wireless/RF cell monitoring unit (CMU) as described herein.

FIG. 2 is a schematic illustration of a set of CMUs in RF communication with a host system within the scope of the disclosure.

FIG. 3 is a schematic illustration of three possible operating modes of an example CMU, including Normal, Transitional, and Long-Term Storage Modes.

The present disclosure is susceptible to modifications and alternative forms, with representative embodiments shown by way of example in the drawings and described in detail below. Inventive aspects of this disclosure are not limited to the particular forms disclosed. Rather, the present disclosure is intended to cover modifications, equivalents, combinations, and alternatives falling within the scope of the disclosure as defined by the appended claims.

### DETAILED DESCRIPTION

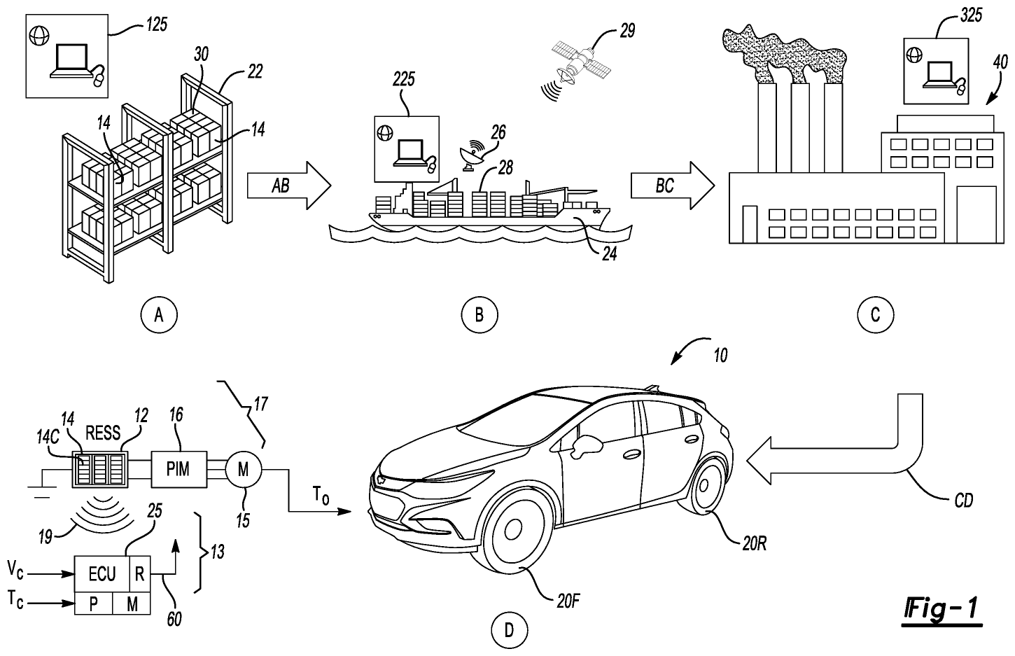

Referring to the drawings, wherein like reference numerals are used to identify like or identical components in the various views, FIG. 1 schematically illustrates a host system 10 having a battery pack or rechargeable energy storage system (RESS) 12 and an electronic control unit (ECU) 25, referred to hereinafter as a host computer 25. The RESS 12 and the host computer 25 collectively form a battery system 13. The host computer 25 includes memory (M) programmed with computer-executable logic for controlling overall operation of the RESS 12 after integration of the battery pack 12 into the host system 10.

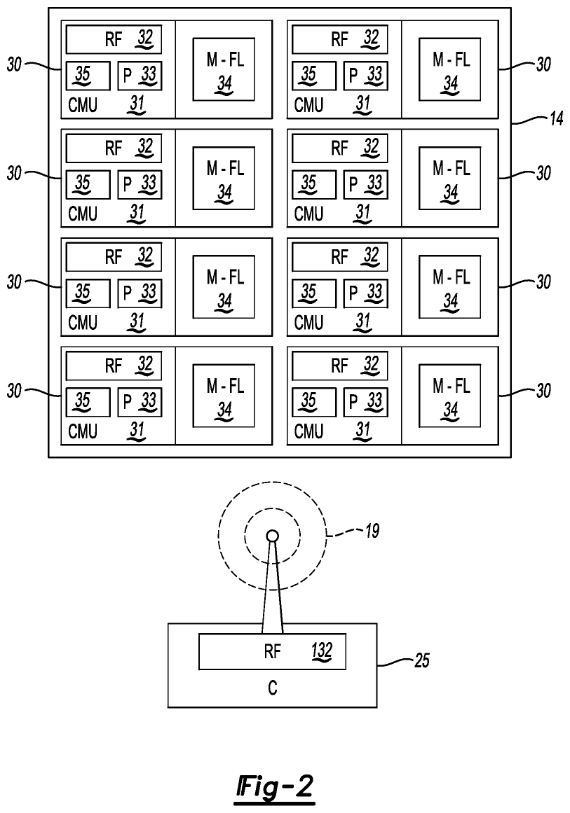

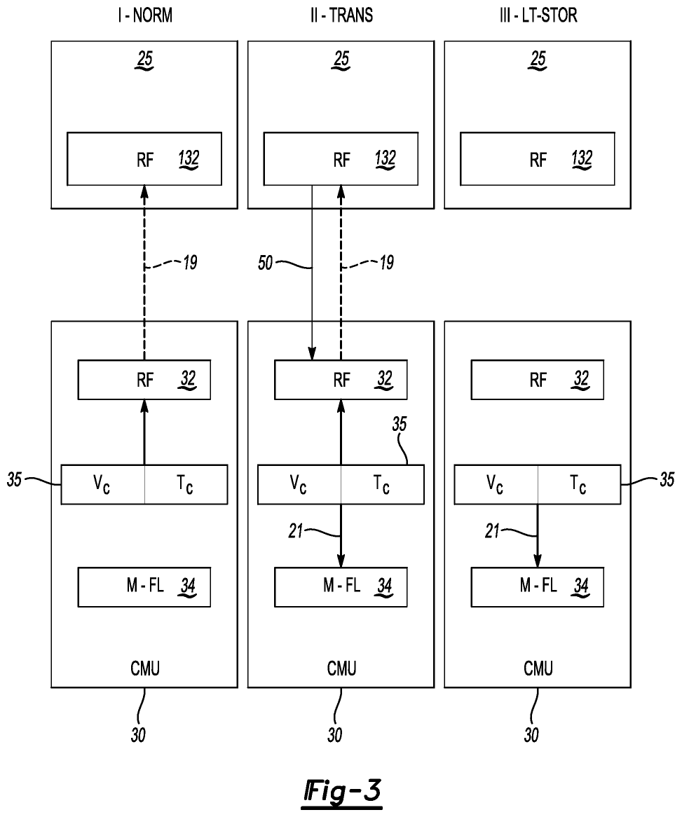

As described below with reference to FIGS. 2 and 3, the RESS 12 includes one or more battery modules 14 each having a plurality of battery cells 14C, e.g., lithium ion or nickel metal hydride battery cells. The battery modules 14 are each configured such that cell sensing, battery module 14-to-battery module 14, and battery module 14-to-host computer 25 communication functionality is integrated directly into the battery modules 14 and performed wirelessly via a corresponding cell monitoring unit (CMU) 30. The disclosed configuration foregoes use of separate hard-wired electronic modules and serial connectors of the type used in the CSB-based topology described generally above.

As part of the present approach, each battery module 14 has a corresponding CMU 30. Each CMU 30 measures and reports battery data inclusive of individual cell voltages (arrow VC) and cell temperatures (TC) for corresponding battery cells 14C residing within the battery module 14 to which the CMU 30 is connected. The CMUs 30 are individually programmed with a software switch that enables separate operating modes of the CMU 30. Such operating modes are described in detail below with particular reference to FIG. 3. In general, a Normal Mode enables real-time monitoring and streaming of radio frequency (RF) battery data 19 to the host computer 25 when the battery modules 14 are eventually integrated into an electrified powertrain 17 or other system and commanded to actively charge or discharge. A Transitional Mode is an intervening mode between Normal Mode and a Long-Term Storage Mode, with the latter mode automatically triggered in response to predetermined dormancy conditions of the battery modules 14.

Further with respect to the construction of the battery module 14, each battery module 14 includes a plurality of individual battery cells (not shown), and embodies a relatively high-voltage energy storage device having an application-specific number of such battery cells. In some applications, as few as two battery modules 14 may be used in the RESS 12, with the actual number being dependent on the required amount of power. For instance, 192 or more individual lithium ion battery cells may be used in an example embodiment collectively capable of outputting at least 18-60 kWh of power depending on the configuration, with a total voltage capacity of 60-300 volts or more. While a vehicle is shown in FIG. 1 as an example embodiment of the host system 10, non-vehicular applications such as static power plants may also be envisioned, as well as non-automotive vehicle applications such as boats, trains, airplanes, robots, and other mobile platforms. For illustrative consistency, the host system 10 of FIG. 1 will be described hereinafter as a vehicle 10 without limiting the scope of possible applications.

The example vehicle 10 includes the above-noted powertrain 17, for instance an electric powertrain as shown or a hybrid electric powertrain. The powertrain 17 may include one or more electric machines (ME) 15 and an optional internal combustion engine (not shown), with the electric machine 15 drawing electrical power from or delivering electrical power to the RESS 12 as needed. The electric machine 15, powered via a power inverter module (PIM) 16 that is electrically connected to the RESS 12, may also generate torque (arrow T_{O}) and transmit the same to front and/or rear drive wheels 20F and 20R, respectively.

Each battery module 14 individually determines a respective cell voltage (arrow V_{C}) and cell temperature (arrow T_{C}) for each battery cell 14C housed within the battery module 14, and also transmits the measured data (arrows V_{C} and T_{C}) wirelessly to the host computer 25 as the RF battery data 19 over a secure RF network, e.g., a 2.4 GHz RF range. The host computer 25 may therefore be remotely positioned with respect to the battery modules 14, such as at least about 0.1 meters (m) or at least 0.5 m away from the battery modules 14, unlike configurations which mount the host computer 25 directly to a surface of the RESS 12.

The host computer 25 may be optionally embodied as a master battery controller, for instance a Battery System Manager (BSM), and may include one or more computer devices each having one or more processors (P) and sufficient amounts of memory (M), e.g., read only memory, random access memory, and electrically-erasable programmable read only memory. The host computer 25 may include a wireless transceiver (R) configured to request transmission of the RF battery data 19 wirelessly from the RESS 12, e.g., via a data request signal 60 transmitted to the battery module 14, and may also be configured to run/execute various software programs in the overall control of the RESS 12 so as to execute control actions. Example control actions may include cell charge balancing operations in which the states of charge of the various battery cells 14C are equalized, e.g., via internal switching control of the battery module 14, as well as health monitoring, electric range estimation, and/or powertrain control actions when integrated into the vehicle 10 of FIG. 1. Control actions may include recording diagnostic codes and/or taking other real-time control actions when the RF battery data 19 is indicative of an impending or actual fault of the battery module 14. As part of such programs, the host computer 25 may receive other signals not described herein.

Also shown in FIG. 1 is a representative lifecycle sequence. Commencing at time point A, assembled battery modules 14 may await transport in a warehouse facility. For instance, a number of the battery modules 14 may be stored temporarily on a rack 22. Another host computer 125 may be present in such a warehouse facility, with data communication between the host computer 125 and the individual battery modules 14 thus possible in some embodiments.

Eventually, the battery modules 14 are removed from the rack 22 and placed on a transport vehicle 24 as indicated by arrow AB. In this instance, the transport vehicle 24 is a container vessel on which is stacked a number of shipping containers 28 each containing a plurality of the battery modules 14. Transportation via the transport vehicle 24 is captured as time point B in FIG. 1. As with time point A, another host computer 225 may be present on the transport vehicle 24. Additionally, the transport vehicle 24 may include a radio transceiver 26 that, in some embodiments, may be placed in remote communication with a communications satellite 29 and/or with the internet.

As indicated by arrow BC, the transport vehicle 24 eventually offloads the shipping containers 28. The battery modules 14 contained therein are transported to an assembly facility 40. A host computer 325 may be present at such an assembly facility 40. In keeping with the example vehicle 10, the assembly facility 40 may be an electric or hybrid electric vehicle assembly plant. Within such an assembly facility 40, as represented by time point C, the battery modules 14, each with a resident CMU 30, are integrated into the vehicle 10 or other host system, e.g., the powertrain 17, such as by assembling an application-suitable number of the battery modules 14 into the RESS 12, connecting the RESS 12 to the PIM 16, and connecting the PIM 16 to the electric machine 15. The electric machine 15 may, in certain embodiments, be coupled to the drive wheels 20F and/or 20R, e.g., via an intervening transmission (not shown).

Once assembly of the vehicle 10 is complete and the vehicle 10 is operational, as represented by arrow CD, the host computer 25 is placed in remote/RF communication with the RESS 12 via individual communication with the CMUs 30.

Referring to FIG. 2, a plurality of the CMUs 30, shown schematically and not to scale, may be mounted to the battery module 14, with a plurality of the battery modules 14 connected together into the RESS 12, e.g., eight battery modules 14 forming the RESS 12 in the non-limiting example configuration of FIG. 2. Each CMU 30 includes a substrate 31, an RF communications circuit 32, a microprocessor (P) 33, flash memory (M-FL) 34, and a cell sense circuit (CS) 35. Other electronic circuit components such as resistors, transistors, diodes, and voltage and temperature sensors may be connected to the substrate 31.

The cell sense circuit 35 is electrically connected to the RF communications circuit 32 through the substrate 31, such as through conductive traces provided thereon and/or therethrough. The cell sense circuit 35 is operable for measuring or otherwise determining a respective cell voltage and cell temperature of each of the battery cells of the battery module 14, as noted above and depicted in FIG. 1 as arrows V_{C} and T_{C}, respectively. Information may be wirelessly broadcast or transmitted to the host computer 25 of FIG. 1 as the RF battery data 19 using the RF communications circuit 32.

The substrate 31 may be optionally embodied as a flex circuit, such as a thin, flexible piece of circuit board having, on its reverse side (not shown), a plurality of relatively flat conductive tabs oriented along a plane that is parallel to a plane of the substrate 31, e.g., alternating pads or squares of different conductive material such as copper and aluminum. Such structure may be suitable for completing an electrical circuit between stacked battery cells of the battery module 14.

Each CMU 30 may be programmed to execute application-specific software to control local battery sensing operations. Such operations include cell sense operations in which battery data 19 inclusive of the above-noted cell voltages (arrow V_{C}) and cell temperatures (arrow T_{C}) are measured and locally recorded and/or transmitted to the host computer 25 or its variants 125, 225, or 325 of FIG. 1. Such host computers 25, 125, 225, 325 may include a corresponding RF communications circuit 132 to enable two-way RF communications with each individual CMU 30.

Other operations conducted by the CMU 30 may include sleep scheduling, wakeup control, health monitoring, active state of charge/cell balancing, etc. The RF communications circuit 32 may employ a 2.4 GHz wireless protocol over a secure wireless network, such that data is transmitted using low-power radio waves. As will be appreciated by one of ordinary skill in the art, the 2.4 GHz protocol generally encompasses a frequency range of about 2.402-2.480 GHz. However, other RF frequency ranges may be used within the scope of the present disclosure.

FIG. 3 schematically depicts the above-noted normal (I-NORM), transitional (II-TRANS), and long-term storage (III-LT-STOR) modes enabled by programmed functionality of the CMUs 30. While illustrated with respect to the host computer 25, the depicted communications may occur with the host computers 125, 225, or 325 of FIG. 1 depending on the location of the battery module 14 at the time of data collection.

Normal Operating Mode (I): this operating mode is similar to real-time monitoring and streaming data output of a hardwired CSB as described above. That is, when the CMU 30 is integrated into a host system, such as the vehicle 10 shown in FIG. 1, and commanded by the host computer 25 to actively charge or discharge its resident battery cells, the CMU 30 is active in a full-power mode. That is, the microprocessors 33 of FIG. 2 are energized and fully functional, and execute instructions to collect and stream the battery data 19 to the host computer 25, e.g., a resident master battery controller or BSM located within the vehicle 10 of FIG. 1. The cell sense circuit 35, including corresponding voltage and temperature sensors, outputs the measured data to the RF communications circuit 32 in real-time, with such output possibly streamed directly to the host computer 25, e.g., in response to the data request signal 60 of FIG. 1. Also in real-time, the RF communications circuit 32 broadcasts and thus relays the battery data 19 to the host computer 25.

Transitional Mode (II): the Transitional Mode is an intervening mode between the above-described Normal Mode and Long-Term Storage Mode described below. Transitional Mode may be executed when the host computer 25 is switching between Normal Mode and Long-Term Storage Mode, or vice versa. A wireless transition signal (arrow 50) may be transmitted by the RF communications circuit 132 to the RF communications circuit 32 of the CMU 30. When transitioning from Normal Mode to the Long-Term Storage Mode, which is the particular mode transition illustrated in FIG. 3, the transition signal (arrow 50) signals the CMU 30 to immediately cease transmission of the battery data 19. Similarly, the transition signal (arrow 50) signals the CMU 30 to commence transmission of the battery data 19 to the host computer 25 when transitioning from Long-Term Storage Mode to Normal Mode. I

Long-term Storage Mode (III): in response to predetermined dormancy conditions, such as the battery module 14 being dormant for a calibrated duration whether due to a fault or system shutdown, the RF communications circuit 32 is activated in a low power consumption mode. The microprocessor 33 (see FIG. 2) of the CMU 30 wakes up at a calibrated interval, e.g., once per hour, day, or other predetermined interval, collects the battery data 19 via the cell sense circuit 35 and temporarily records the battery data 19 in its resident flash memory 34 as indicated by arrow 21 in FIG. 3. The flash memory 34 may include a linear or circular data buffer having a suitable number of data slots to cover the anticipated duration of dormancy, with each data slot automatically overwritten in a first-in first-out sequence when the buffer or array is full. The CMU 30 then goes into a low-power “sleep” mode until the next battery data sample is triggered.

Referring again to FIG. 1, the approach depicted in FIGS. 2 and 3 enabled uninterrupted local monitoring of the battery modules 14 without respect to connectivity to the host computer 25, which itself may not be present during extended periods of dormancy of the battery modules 14. The battery modules 14 may be assembled into the RESS 12, with the various CMUs 30 forming a nodal mesh network of wireless monitoring boards. Extended dormancy due to power cut-off to the battery module 14, regardless of cause, is thus treated by programmed low-power, periodic sampling of the battery data 19.

As will be appreciated by those of ordinary skill in the art, the above disclosure enables a method of monitoring and controlling the battery module 14 of FIG. 1. For instance, such a method may include determining, via the respective microprocessors 33 of the CMUs 30 shown in FIG. 2, when the battery module 14 has been dormant for a predetermined dormancy duration during which the battery cells 14C are neither charging nor discharging. Responsive to the battery module being dormant for the predetermined dormancy duration, the method may include selectively executing the Long-Term Data Storage Mode described above, including pairing the RF communications circuit 32 of each of the CMUs 30 with a respective one of the cell sense circuits 35, collecting the battery data 19 at a calibrated interval using the cell sense circuit 35, and wirelessly transmitting the battery data via the RF communications circuit 32 to flash memory 34 of the CMU 30 for storage therein.

Using the satellite 29 of FIG. 1 or web-based connectivity with a warehouse or the transport vehicle 24, for instance, enables periodic triggering of Normal Mode, in which case the host computer 125, 225, or 325 may initiate a control action responsive to the battery data 19 falling outside of calibrated ranges, e.g., cell temperatures exceeding a calibrated maximum temperature and/or cell voltages dropping below a threshold voltage. As the RF communications circuit 32 is connected to the cell sense circuit 35 and the microprocessor 33 of FIG. 2, the CMU 30 is able to wake itself up, gather battery data 19 using the cell sense circuit 35, store the collected battery data 19 in flash memory 34, and then go back to sleep to conserve idle power consumption. Low-power mode includes using a sufficient amount of energy to keep the RF communications circuit 32 of each CMU 30 wirelessly paired with the other components of the CMU 30, and preferably no more. This is substantially less energy than that which is ordinarily consumed in Normal Mode. As a result, lapses in monitoring of the battery modules 14 are avoided and, where the host computers 25, 125, 225, or 325 are present, real-time preemptive control actions may be taken to protect the battery module 14 experiencing or trending toward a fault condition.

While the best modes for carrying out the disclosure have been described in detail, those familiar with the art to which this disclosure relates will recognize various alternative designs and embodiments lying within the scope of the appended claims. It is intended that all matter contained in the above description and/or shown in the accompanying drawings shall be interpreted as illustrative only and not as limiting.

1. A battery module comprising:
a plurality of battery cells;
a cell monitoring unit (CMU) mounted to the battery module and including:
a substrate;
a radio frequency (RF) communications circuit connected to the substrate;
a cell sense circuit connected to the substrate and in wireless communication with the RF communications circuit, wherein the cell sense circuit is operable for measuring battery data, including a cell voltage and a cell temperature of each respective one of the battery cells;
a microprocessor in communication with the RF communications circuit and the cell sense circuit; and
flash memory;
wherein the microprocessor is configured to determine when the battery module has been dormant for a predetermined dormancy duration during which the battery cells are neither charging nor discharging, and, responsive to the battery module being dormant for the predetermined dormancy duration, to selectively execute a Long-Term Data Storage Mode in which the RF communications circuit is automatically paired with the cell sense circuit, collects the battery data at a calibrated interval, and wirelessly transmits the battery data to the flash memory for storage therein.

2. The battery module of claim 1, wherein the battery module is in wireless communication with a host computer, and wherein the microprocessor is configured, responsive to a data request signal from the host machine, to wirelessly transmit the battery data from the flash memory to the host computer.

3. The battery module of claim 2, wherein the battery module is configured for use in a host system, and wherein the host computer is aboard a transport vehicle or in a warehouse prior to integration of the battery module into the host system.

4. The battery module of claim 2, wherein the microprocessor is configured to receive a transition signal from the host computer indicative of an impending mode transition from the Long-Term Storage Mode, and to terminate wireless transmission of the battery data to the flash memory responsive to receiving the transition signal.

5. The battery module of claim 2, wherein the battery module is used aboard a vehicle having an electrified transmission, and the host computer is a master battery controller of the vehicle.

6. The battery module of claim 5, wherein the predetermined dormancy duration is at least one week, and the calibrated interval is between once per hour and once per day.

7. A host system comprising:
a host computer; and
a plurality of battery modules, each respective one of which includes:
a plurality of battery cells; and
a cell monitoring unit (CMU) having:
flash memory;
a radio frequency (RF) communications circuit connected to a substrate;
a cell sense circuit connected to the substrate and in wireless communication with the host computer via the RF communications circuit when operating in a Normal Mode, wherein the cell sense circuit is operable for measuring battery data, including cell voltages and cell temperatures of each respective battery cell of the respective battery module, and wherein the Normal Mode includes continuously streaming the battery data to the host computer in real-time without recording the battery data in the flash memory; and
a microprocessor connected to the RF communications circuit and to the cell sense circuit;
wherein the microprocessor is configured to determine when the battery pack has been dormant for a predetermined dormancy duration, and, responsive to the battery pack being dormant for the predetermined dormancy duration, to selectively execute a Long-Term Data Storage Mode in which the RF communications circuit is automatically paired with the cell sense circuit when the battery cells are not charging or discharging, collects the battery data at a calibrated interval, wirelessly transmits the battery data to the flash memory for storage therein, and, responsive to a data request signal from the host computer, to wirelessly transmit the battery data from the flash memory to the host computer.

8. The host system of claim 7, wherein the host computer is configured to execute a control action with respect to the battery module, including recording a diagnostic code when the battery data is indicative of at least one of a low cell voltage and a high cell temperature relative to a corresponding calibrated threshold value.

9. The host system of claim 7, wherein the control action includes commanding the CMU to conduct a charge rebalancing operation of the battery cells.

10. The host system of claim 7, wherein the microprocessor is configured to receive a transition signal from the host computer indicative of a mode transition from the Long-Term Storage Mode, and to terminate wireless transmission of the battery data to the flash memory responsive to receiving the transition signal.

11. The host system of claim 7, wherein the battery module is part of a motor vehicle having an electrified transmission, and the host computer is a master battery controller of the vehicle.

12. The host system of claim 7, wherein the predetermined dormancy duration is at least one week, and the calibrated interval is between once per hour and once per day.

13. A method of monitoring and controlling a battery module having a plurality of battery cells and a cell monitoring unit (CMU) mounted to the battery module, the method comprising:
determining, via a microprocessor of the CMU in radio frequency (RF) communication with an RF communications circuit and a cell sense circuit of the CMU, when the battery module has been dormant for a predetermined dormancy duration in which the battery cells are neither charging nor discharging; and
responsive to the battery module being dormant for the predetermined dormancy duration:
selectively executing a Long-Term Data Storage Mode, including pairing a radio frequency (RF) communications circuit of the CMU with a cell sense circuit of the CMU;
collecting battery data at a calibrated interval using the cell sense circuit, the battery data including cell voltages and cell temperatures of each respective one of the battery cells; and
wirelessly transmitting the battery data via the RF communications circuit to flash memory of the CMU for storage therein.

14. The method of claim 13, wherein the battery module is in RF communication with a host computer, the method further comprising:
receiving a data request signal from the host computer via the RF communications circuit; and
responsive to a data request signal from the host machine, wirelessly transmitting the battery data from the flash memory to the host computer via the RF communications circuit.

15. The method of claim 14, further comprising:
receiving a transition signal from the host computer indicative of an impending mode transition from the Long-Term Storage Mode; and
terminating wireless transmission of the battery data to the flash memory responsive to receipt of the transition signal.

16. The method of claim 14, wherein the battery module is used as part of a battery pack of a vehicle having an electrified transmission, and the host computer is a master battery controller of the vehicle.

17. The method of claim 14, wherein the predetermined dormancy duration is at least one week, and the calibrated interval is between once per hour and once per day.
